(19) United States
(12) Patent Application Publication
(10) Pub. No.: US 2015/0123402 A1
(43) Pub. Date: May 7, 2015

(54) MAGNETIC STRUCTURE COMBINING NORMAL MODE AND COMMON MODE INDUCTANCE

(71) Applicant: General Electric Company, Schenectady, NY (US)

(72) Inventors: Robert Gregory Wagoner, Roanoke, VA (US); Allen Michael Ritter, Roanoke, VA (US); Govardhan Ganireddy, Bangalore (IN)

(73) Assignee: General Electric Company, Schenectady, NY (US)

(21) Appl. No.: 14/070,783

(22) Filed: Nov. 4, 2013

(51) Int. Cl. H01F 30/06; H02P 9/00; H01F 3/14; F03D 9/00

(52) U.S. Cl. CPC H01F 30/06; F03D 9/003; H02P 9/007; H01F 3/14
USPC 290/44; 336/170

(57) ABSTRACT

Magnetic components that can be used to provide normal mode and common mode inductance in a power system, such as a wind-driven doubly fed induction generator system, are provided. The magnetic components can include a structure that combines both normal mode inductors and common mode inductors on a common core. In particular, the magnetic components can include specific winding and core arrangements which couple a common mode inductor and a normal mode inductor onto a single core with at least three legs. The structure of the magnetic components can be smaller in size, can have lower weight, and can have a lower cost than typical solutions to providing common mode and normal mode inductance in a power system.

### FIELD OF THE INVENTION

The present disclosure relates generally to magnetic components for use in power systems, and more particularly to magnetic structures that combine normal mode and common mode inductance.

### BACKGROUND OF THE INVENTION

Power systems, such as wind driven doubly-fed induction generator (DFIG) systems, often require magnetic components such as inductors for filtering and other purposes. For instance, normal mode and common mode chokes can be used to filter high frequency components in a power system. A complex set of magnetic components, including both common mode chokes and normal mode inductors, can be required in power systems, for instance, to reduce noise and other issues.

For example, a wind-driven DFIG system can include a battery energy storage system coupled to a DC bus of a power converter used in the DFIG system. In such a system, a high common mode voltage can be imposed on the battery energy storage system as a result of the switching of semiconductor devices (e.g. insulated gate bipolar transistors (IGBTs)) in the power converter. The high common mode voltage can feed through capacitances to ground around the battery energy storage system causing unacceptably high currents to flow through these capacitances. This can result in electrical noise problems with electronic control circuits used to control the power converter. Magnetic components such as normal mode chokes and common mode chokes coupled between the DC bus and the battery energy storage system can reduce these effects. However, the magnetic components can require complex configurations and can have significant size, weight, and cost requirements.

Thus, a need exists for improved magnetic components that can provide both common mode and normal inductance to a power system. A magnetic component design that can reduce the size, weight, and cost of the magnetic components would be particularly useful.

### BRIEF DESCRIPTION OF THE INVENTION

Aspects and advantages of the invention will be set forth in part in the following description, or may be obvious from the description, or may be learned through practice of the invention.

One example aspect of the present disclosure is directed to a magnetic component for providing common mode and normal mode inductance in a power system. The magnetic component includes a core having a plurality of legs. The plurality of legs includes a first leg, a second leg, and a third leg. Each of the plurality of legs is configured to provide a flux path in the core. The magnetic component includes at least one common mode winding. The at least one common mode winding can be disposed about the first leg. The at least one common mode winding is configured to provide a common mode inductance for the power system. The magnetic component includes at least one normal mode winding disposed about the second leg. The normal mode winding is configured to provide a normal mode inductance for the power system. The at least one common mode winding is coupled between the at least one normal mode winding and a DC output of the magnetic component.

Another example aspect of the present disclosure is directed to a wind turbine power system. The power system includes a wind driven generator configured to generate AC power and a power converter coupled to the generator. The power converter includes a first converter configured to convert AC power to DC power and a second converter configured to convert DC power to AC power. A DC bus is coupled between the first converter and the second converter. The power system further includes a magnetic component. The magnetic component includes a core having a plurality of legs. The plurality of legs includes a first leg, a second leg, and a third leg. Each of the plurality of legs is configured to provide a flux path in the core. The magnetic component includes at least one common mode winding. The at least one common mode winding can be disposed about the first leg. The at least one common mode winding is configured to provide a common mode inductance for the power system. The magnetic component includes at least one normal mode winding disposed about the second leg. The normal mode winding is configured to provide a normal mode inductance for the power system. The at least one common mode winding is coupled between the at least one normal mode winding and a DC output of the magnetic component.

Variations and modifications can be made to these example aspects of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a block diagram of an example power converter system;

FIG. 2 depicts an example energy storage system coupled to the a power converter system according to an example embodiment of the present disclosure;

FIG. 3 depicts a magnetic component according to an example embodiment of the present disclosure;

FIG. 4 depicts a magnetic component according to another example embodiment of the present disclosure;

FIG. 5 depicts a magnetic component according to another example embodiment of the present disclosure;

FIG. 6 depicts a magnetic component according to another example embodiment of the present disclosure;

FIG. 7 depicts a magnetic component according to another example embodiment of the present disclosure;

FIG. 8 depicts a magnetic component according to another example embodiment of the present disclosure; and

FIG. 9 depicts a magnetic component according to another example embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, example aspects of the present disclosure are directed to magnetic components that can be used to provide normal mode and common mode inductance in a power system, such as a wind-driven doubly fed induction generator system. The magnetic components can include a structure that combines both normal mode inductors and common mode inductors on a common core. In particular, the magnetic components can include specific winding and core arrangements which couple at least one common mode inductor and at least one normal mode inductor onto a single core with at least three legs. The structure of the magnetic components according to example aspects of the present disclosure can be smaller in size, can have lower weight, and can have a lower cost than typical solutions to providing common mode and normal mode inductance in a power system.

More particularly, the magnetic component can include a core. The core can be a material having a high magnetic permeability that can provide magnetic flux paths in the core. For instance, the core can be iron, ferrite, or other ferromagnetic material. The core can include a plurality of legs, such as a first leg, a second leg, and a third leg. Each leg can be configured to provide a flux path through the core.

The magnetic component can include at least one normal mode winding and at least one common mode winding disposed about different legs of the core. The normal mode winding can be configured to provide normal mode inductance (i.e. differential mode inductance) for the power system. The common mode winding can be configured to provide common mode inductance for the power system.

In a particular implementation of the present disclosure, the magnetic component can include a first common mode winding and a second common mode winding. The magnetic component can further include a first normal mode winding and a second common mode winding. The first normal mode winding can be coupled to a first input to the magnetic component (e.g. a positive DC input). The second normal mode winding can be coupled to a second input to the magnetic component (e.g. a negative DC input). The first common mode winding can be electrically coupled between the first normal mode winding and a first output of the magnetic component (e.g. a positive DC output). The second common mode winding can be coupled to a second output of the magnetic component (e.g. a negative DC output).

The present disclosure refers to an “input” and an “output” of the magnetic component for purposes of illustration and discussion. Those of ordinary skill in the art, using the disclosures provided herein, will understand that an input to the magnetic component can act as either an input or as an output to the magnetic component. Similarly, an output to the magnetic component can act as either an input or an output to the magnetic component.

Example aspects of the present disclosure are directed to the configuration and arrangement the normal mode windings and the common mode windings on the magnetic core to provide an improved magnetic component. For instance, the normal mode windings and the common mode windings can be configured and arranged such that the magnetic component can be used to provide both common mode inductance and normal mode inductance to a power system.

For instance, in one example embodiment, the first and second common mode windings can be disposed about the first leg of the core. The first normal mode winding can be disposed about the second leg of the core. The second normal mode winding can be disposed about the third leg of the core. The legs can be arranged in any order. For instance, in one implementation, the first leg having the first and second common mode windings can be in a center position of the core between the second and third legs to balance of the impedances of the normal mode windings.

The core can include air gaps in one or more of the plurality of legs to adjust the reluctance of the legs. For instance, in one implementation, an air gap can be provided in the second leg having the first normal mode winding and in the third leg having the second normal mode winding. In another implementation, an air gap can be provided in the first leg, the second leg, and the third leg of the core. The size of the air gaps may or may not be the same depending on the particular application of the magnetic component. For instance, the size of the air gaps in the legs of the core can be about the same size (e.g. within 10% of the size of the largest air gap).

In another example embodiment, the first and second common mode windings can be disposed about the first leg of the core. The first and second normal mode windings can be disposed about the second leg of the core. The third leg of the magnetic component can include no windings. The legs can be arranged in any order without deviating from the scope of the present disclosure.

An air gap can be provided in one or more of the legs of the magnetic component according to this example embodiment of the present disclosure. For instance, an air gap can be provided in the first leg having the common mode windings and the second leg having the normal mode windings. In another implementation, an air gap can be provided only in the second leg having the normal mode windings. The size of the air gaps may or may not be the same depending on the particular application of the magnetic component. For instance, the size of the air gap in the first leg having the common mode windings can be smaller than the size of the air gap in the second leg having the normal mode windings.

In yet another example embodiment, the first and second normal mode windings can be disposed about the first leg of the core. The first common mode winding can be disposed about the second leg of the core. The second common mode winding can be disposed about the third leg of the core. The legs can be arranged in any order without deviating from the scope of the present disclosure.

Similar to other example embodiments of the present disclosure, an air gap can be provided in one or more of the legs of the magnetic component according to this example embodiment of the present disclosure. For instance, an air gap can be provided in the first leg having the normal mode windings. In another implementation, an air gap can be provided in the first leg, second leg, and third leg of the windings. The size of the air gaps may or may not be the same depending on the particular application of the magnetic component. For instance, the size of the air gap in the first leg having the normal mode windings can be selected to vary the normal mode inductance of the magnetic component. The size of the air gaps in the second leg having the first common mode winding and the third leg having the second common mode winding can be selected to vary the common mode inductance of the magnetic component.

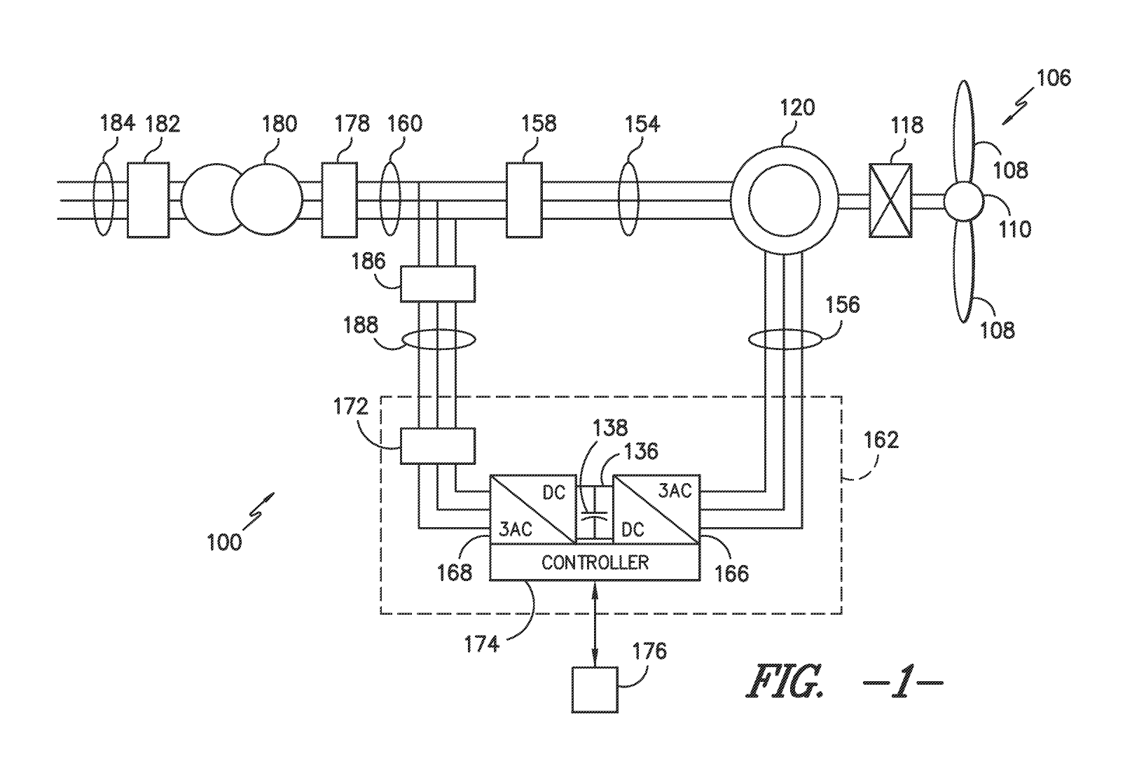

With reference now to the FIGS., example embodiments of the present disclosure will now be discussed in detail. FIG. 1 depicts an example wind driven doubly-fed induction generator (DFIG) system 100. The present disclosure is discussed with reference to the DFIG wind turbine system 100 of FIG. 1 for purposes of illustration and discussion. Those of ordinary skill in the art, using the disclosures provided herein, should understand that aspects of the present disclosure are also applicable in other power systems, such as wind, solar, gas turbine, or other suitable power generation system.

In the example system 100, a rotor 106 includes a plurality of rotor blades 108 coupled to a rotating hub 110, and together define a propeller. The propeller is coupled to an optional gear box 118, which is, in turn, coupled to a generator 120. In accordance with aspects of the present disclosure, the generator 120 is a doubly fed induction generator (DFIG) 120.

DFIG 120 is typically coupled to a stator bus 154 and a power converter 162 via a rotor bus 156. The stator bus 154 provides an output multiphase power (e.g. three-phase power) from a stator of DFIG 120 and the rotor bus 156 provides an output multiphase power (e.g. three-phase power) of a rotor of the DFIG 120. Referring to the power converter 162, DFIG 120 is coupled via the rotor bus 156 to a rotor side converter 166. The rotor side converter 166 is coupled to a line side converter 168 which in turn is coupled to a line side bus 188.

In example configurations, the rotor side converter 166 and the line side converter 168 are configured for normal operating mode in a three-phase, pulse width modulation (PWM) arrangement using insulated gate bipolar transistor (IGBT) switching elements. The rotor side converter 166 and the line side converter 168 can be coupled via a DC bus 136 across which is the DC bus capacitor 138.

The power converter 162 can be coupled to a controller 174 to control the operation of the rotor side converter 166 and the line side converter 168. It should be noted that the controller 174, in typical embodiments, is configured as an interface between the power converter 162 and a control system 176. The controller 174 can include any number of control devices. In one implementation, the controller 174 can include a processing device (e.g. microprocessor, microcontroller, etc.) executing computer-readable instructions stored in a computer-readable medium. The instructions when executed by the processing device can cause the processing device to perform operations, including providing control commands (e.g. pulse width modulation commands) to the switching elements of the power converter 162.

In typical configurations, various line contactors and circuit breakers including, for example, grid breaker 182 can be included for isolating the various components as necessary for normal operation of DFIG 120 during connection to and disconnection from the electrical grid 184. A system circuit breaker 178 can couple the system bus 160 to a transformer 180, which is coupled to the electrical grid 184 via grid breaker 182.

In operation, alternating current power generated at DFIG 120 by rotating the rotor 106 is provided via a dual path to electrical grid 184. The dual paths are defined by the stator bus 154 and the rotor bus 156. On the rotor bus side 156, sinusoidal multi-phase (e.g. three-phase) alternating current (AC) power is provided to the power converter 162. The rotor side power converter 166 converts the AC power provided from the rotor bus 156 into direct current (DC) power and provides the DC power to the DC bus 136. Switching elements (e.g. IGBTs) used in bridge circuits of the rotor side power converter 166 can be modulated to convert the AC power provided from the rotor bus 156 into DC power suitable for the DC bus 136.

The line side converter 168 converts the DC power on the DC bus 136 into AC output power suitable for the electrical grid 184. In particular, switching elements (e.g. IGBTs) used in bridge circuits of the line side power converter 168 can be modulated to convert the DC power on the DC bus 136 into AC power on the line side bus 188. The AC power from the power converter 162 can be combined with the power from the stator of DFIG 120 to provide multi-phase power (e.g. three-phase power) having a frequency maintained substantially at the frequency of the electrical grid 184 (e.g. 50 Hz/60 Hz).

Various circuit breakers and switches, such as grid breaker 182, system breaker 178, stator sync switch 158, converter breaker 186, and line contactor 172 can be included in the system 100 to connect or disconnect corresponding buses, for example, when current flow is excessive and can damage components of the wind turbine system 100 or for other operational considerations. Additional protection components can also be included in the wind turbine system 100.

The power converter 162 can receive control signals from, for instance, the control system 176 via the controller 174. The control signals can be based, among other things, on sensed conditions or operating characteristics of the wind turbine system 100. Typically, the control signals provide for control of the operation of the power converter 162. For example, feedback in the form of sensed speed of the DFIG 120 can be used to control the conversion of the output power from the rotor bus 156 to maintain a proper and balanced multi-phase (e.g. three-phase) power supply. Other feedback from other sensors can also be used by the controller 174 to control the power converter 162, including, for example, stator and rotor bus voltages and current feedbacks. Using the various forms of feedback information, switching control signals (e.g. gate timing commands for IGBTs), stator synchronizing control signals, and circuit breaker signals can be generated.

According to a particular aspect of the present disclosure, the DFIG system 100 of FIG. 1 can be coupled to an energy storage system. The energy storage system can be used to provide power to the DC bus 136 under certain conditions. For instance, the energy storage system can be used to provide power to the DC bus 136 to increase output of the power system 100 when wind speed drops. Power can be supplied and stored in the energy storage system during operation of the DFIG system 100.

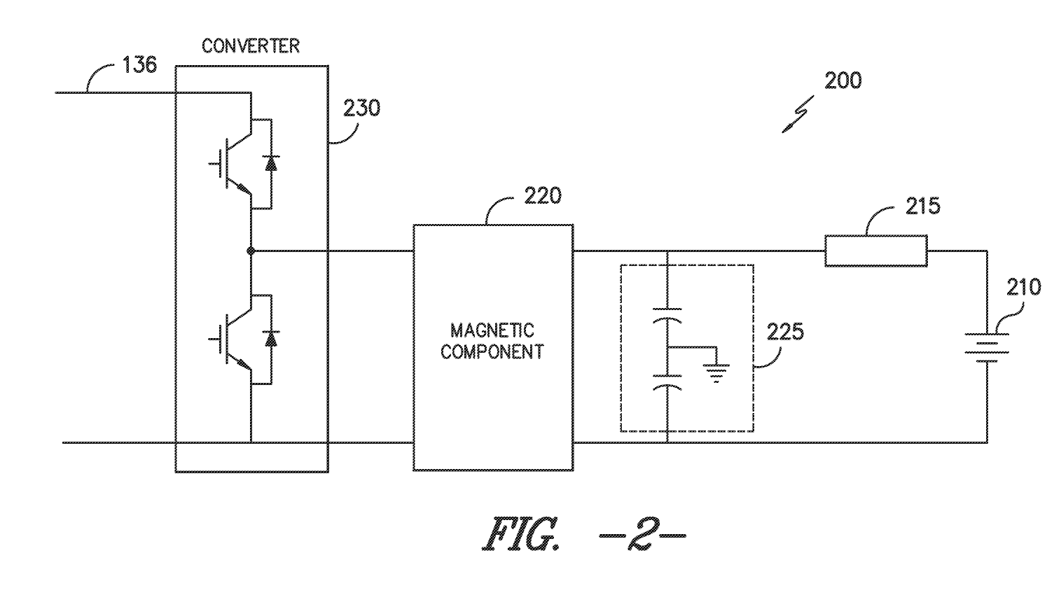

FIG. 2 depicts an example energy storage system 200 can be coupled to the DC bus 136 of a power converter. The energy storage system 200 can include an energy storage device 210. The energy storage device 210 can be any suitable device or system for storing DC power, such as a battery, a capacitor, a fuel cell, or other suitable energy storage system 210. The energy storage device can be coupled to the DC bus 136 via a converter 230, such as a DC to DC converter. The converter 230 can convert the DC power on the DC bus to a DC voltage that is suitable for application to the energy storage device 210. The converter 230 can be a buck converter, a boost converter, a buck/boost converter, or other suitable converter.

During times of high power output, the energy storage device 210 can receive power from the DC bus 136 to charge up the energy storage device 210. During times of low power output, the energy storage device 210 can provide power to the DC bus 136 for use in boosting output of the power system. Switching element 215 can be used to selectively couple the energy storage device 210 to the DC bus 136. The switching element 215 can be, for instance, a switch, relay, contactor, or other suitable switching element.

FIG. 2 depicts a magnetic component 220 coupled between the DC bus 136 and the energy storage device 210. The magnetic component 220 in conjunction with filter capacitors 225 can be used to filter unwanted noise and other effects in the energy storage system 200. According to example aspects of the present disclosure, the magnetic component 210 can arrange normal mode windings and common mode windings on a single core to provide normal mode and common mode inductance to the power system. In this way, the magnetic component can be used to filter both differential mode noise and common mode noise in the energy storage system.

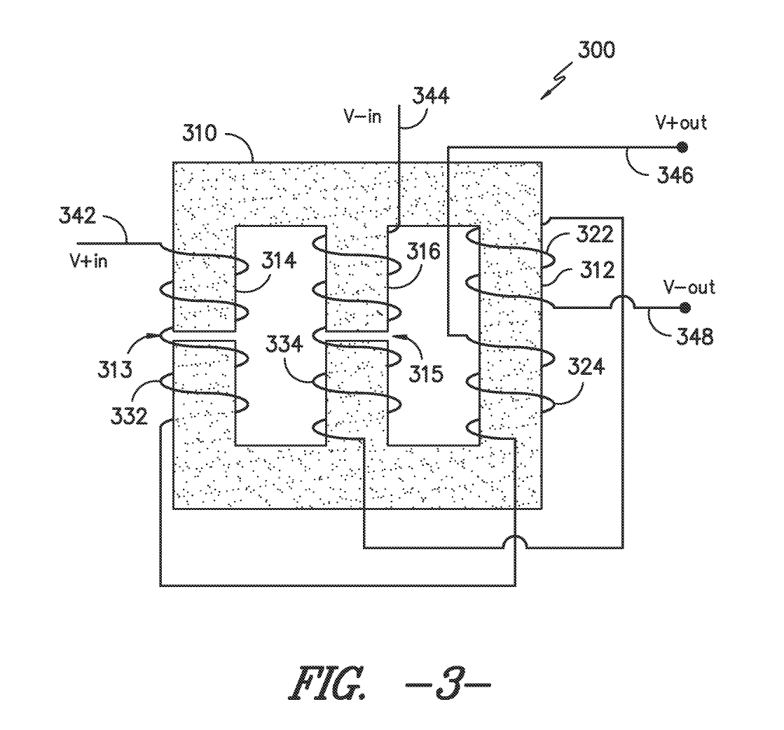

FIG. 3 depicts a magnetic component 300 according to an example embodiment of the present disclosure. The magnetic component 300 includes a core 310 of a material with high magnetic permeability, such as iron, a ferrite, or other ferromagnetic material. The core 310 has three legs, including a first leg 312, a second leg 314, and a third leg 316. Each of the first leg 312, the second leg 314, and the third leg 316 can provide a flux path through the core 310.

The magnetic component 300 can further include a first common mode winding 322, a second common mode winding 324, a first normal mode winding 332, and a second normal mode winding 334. The first normal mode winding 332 can be electrically coupled to a first input 342 (e.g. a positive DC input) of the magnetic component 300. The second normal mode winding 334 can be electrically coupled to a second input 344 (e.g. a negative DC input) of the magnetic component 300. The first common mode winding 322 can be electrically coupled between the first normal mode winding 332 and a first output 346 (e.g. a positive DC output) of the magnetic component. The second common mode winding 324 can be electrically coupled between the second normal mode winding 334 and a second output 348 (e.g. a negative DC output).

The first common mode winding 322 and the second common mode winding 324 can be disposed about the first leg 312 of the core 310. The first normal mode winding 332 can be disposed about the second leg 314 of the core 310. The second normal mode winding 334 can be disposed about the third leg 316 of the core 310.

The second leg 314 can have an air gap 313 to affect the reluctance of the second leg 314 and the normal mode inductance of the first normal mode winding 334. The third leg 316 can have an air gap 315 to affect the reluctance of the third leg 316 and the normal inductance of the second normal mode winding 336. The air gaps 313 and 315 can be about the same size.

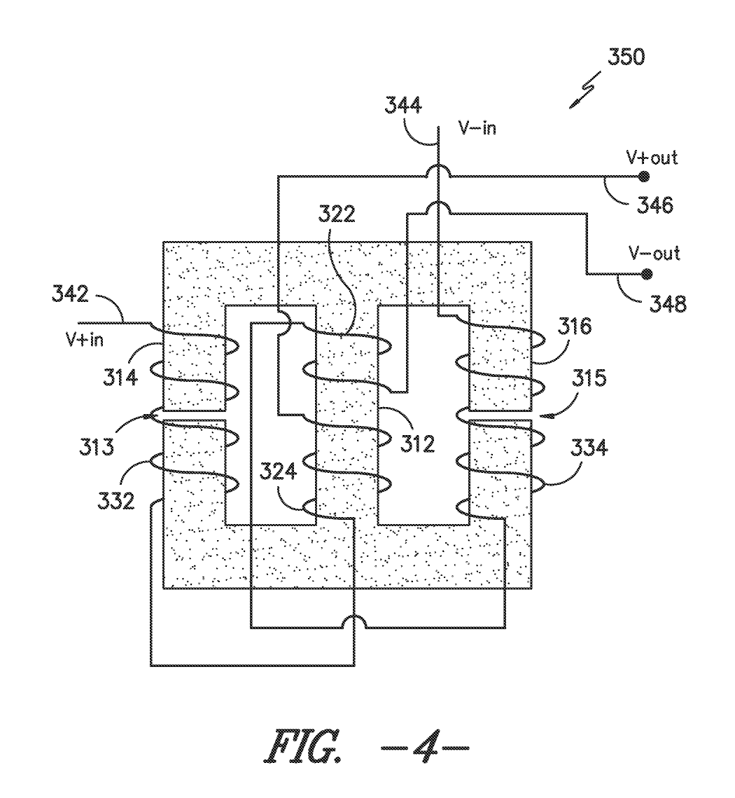

The legs 312, 314, and 316 of the core 310 can be arranged in any order. For instance, FIG. 4 depicts a magnetic component 350 according to another example embodiment of the present disclosure. The magnetic component 350 is similar to the magnetic component 300 if FIG. 3. However, the first leg 312 of the core 310 of the magnetic component 350 of FIG. 4 is arranged between the second leg 314 and the third leg 316. This can balance the impedance of the first normal mode winding 332 on the second leg 314 and the second normal mode winding 334 on the second leg.

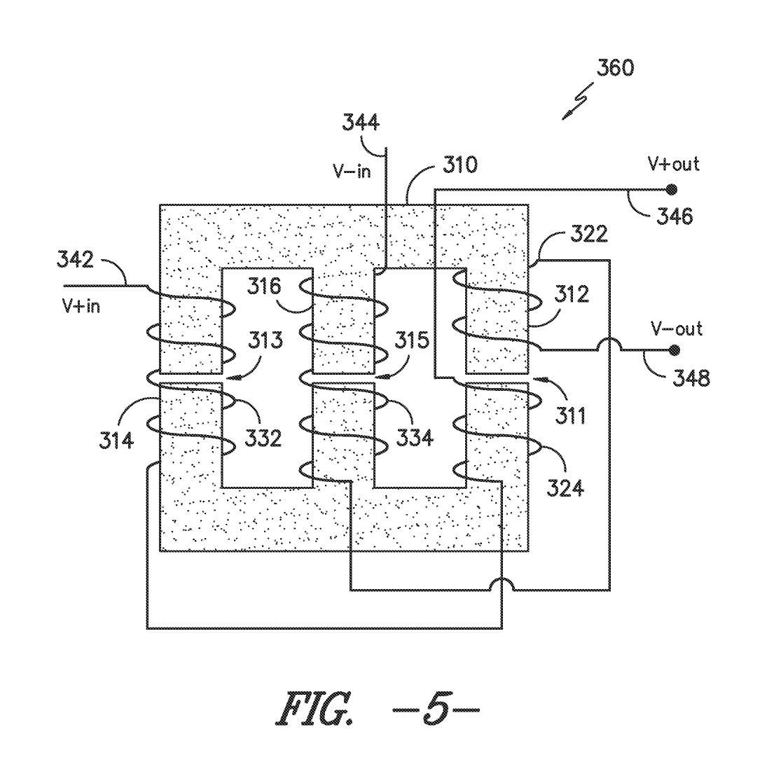

FIG. 5 depicts a magnetic component 360 according to another example embodiment of the present disclosure. The magnetic component 360 is similar to the magnetic component 300 of FIG. 3. However, an air gap 311 is provided in the first leg 312 of the core 310. The air gap 311 can affect the reluctance of the first leg 312 and the common mode inductance of the first common mode winding 322 and the second common mode winding 324. The air gap 311 can be about the same size as the air gaps 313 and 315.

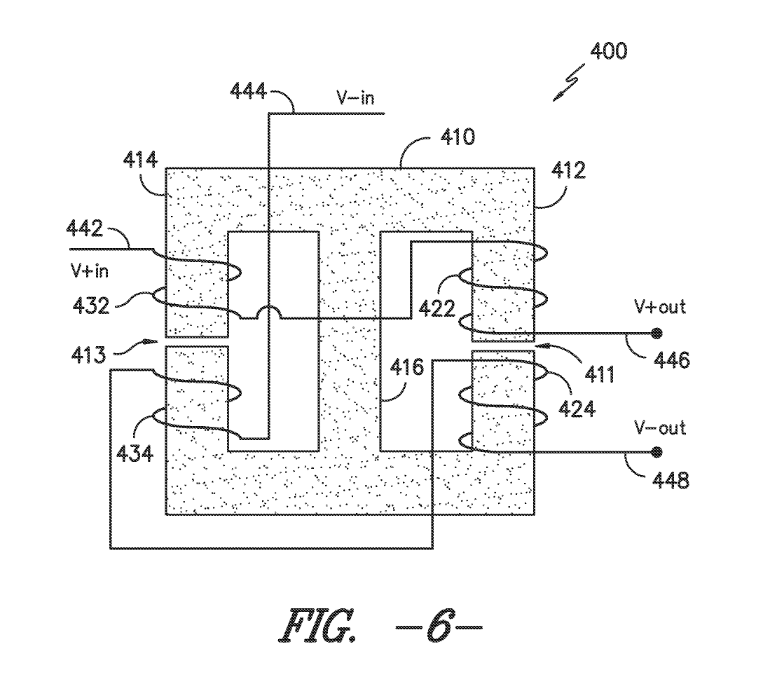

FIG. 6 depicts a magnetic component 400 according to another example embodiment of the present disclosure. The magnetic component 400 includes a core 410 of a material with high magnetic permeability, such as iron, a ferrite, or other ferromagnetic material. The core 410 has three legs, including a first leg 412, a second leg 414, and a third leg 416. Each of the first leg 412, the second leg 414, and the third leg 416 can provide a flux path through the core 410.

The magnetic component 400 further includes a first common mode winding 422, a second common mode winding 424, a first normal mode winding 432, and a second normal mode winding 434. The first normal mode winding 432 can be electrically coupled to a first input 442 (e.g. a positive DC input) of the magnetic component 400. The second normal mode winding 434 can be electrically coupled to a second input 444 (e.g. a negative DC input) of the magnetic component 400. The first common mode winding 422 can be electrically coupled between the first normal mode winding 432 and a first output 446 (e.g. a positive DC output) of the magnetic component. The second common mode winding 424 can be electrically coupled between the second normal mode winding 434 and a second output 448 (e.g. a negative DC output).

The first common mode winding 422 and the second common mode winding 424 can be disposed about the first leg 412 of the core 410. The first normal mode winding 432 and the second normal mode winding 442 can be disposed about the second leg 414 of the core 410. The third leg 416 can contain no windings.

The first leg 412 can have an air gap 411 to affect the reluctance of the first leg 412 and the common mode inductance provided by the first common mode winding 422 and the second common winding 424. The second leg 314 can have an air gap 413 to affect the reluctance of the second leg 414 and the normal mode inductance provided by the first normal mode winding 432 and the second normal mode winding 434. The air gap 313 can be larger in size than the air gap 311.

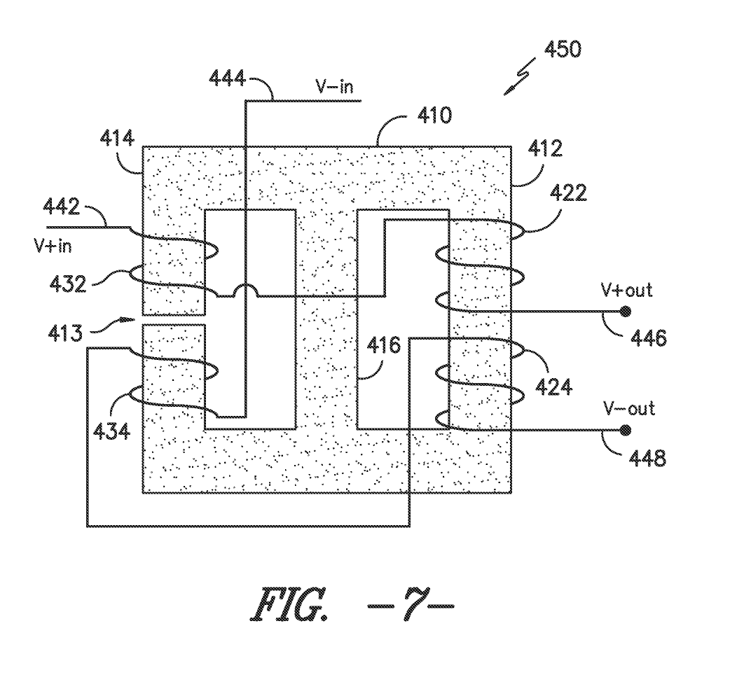

FIG. 7 depicts a magnetic component 450 according to another example embodiment of the present disclosure. The magnetic component 450 is similar to the magnetic component 400 of FIG. 6. However, no air gap is provided in first leg 412 of the core 422.

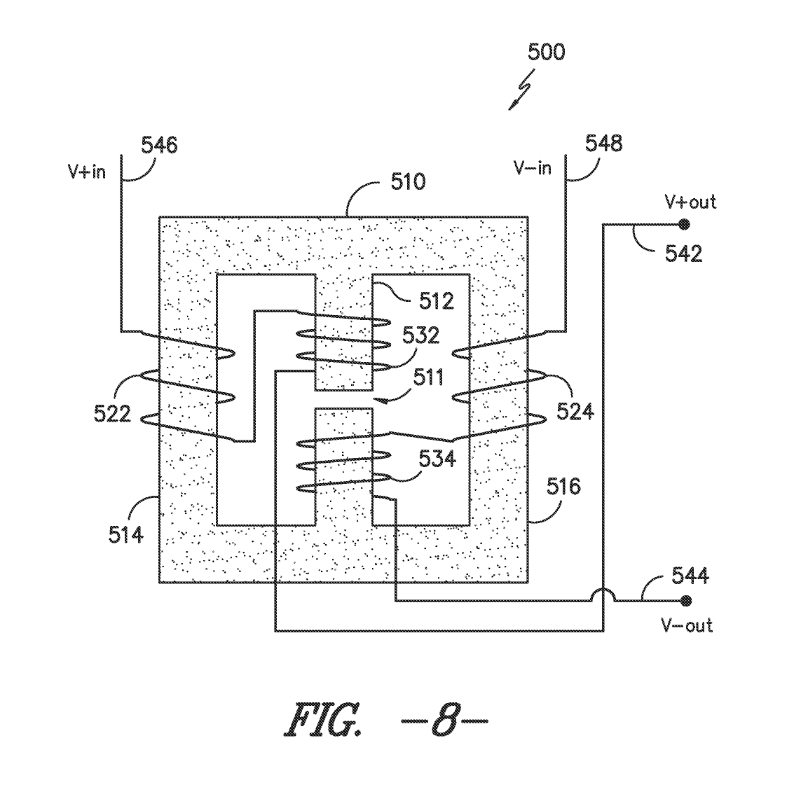

FIG. 8 depicts a magnetic component 500 according to another example embodiment of the present disclosure. The magnetic component 500 includes a core 510 of a material with high magnetic permeability, such as iron, a ferrite, or other ferromagnetic material. The core 510 has three legs, including a first leg 512, a second leg 514, and a third leg 516. Each of the first leg 512, the second leg 514, and the third leg 516 can provide a flux path through the core 510.

The magnetic component 500 further includes a first common mode winding 522, a second common mode winding 524, a first normal mode winding 532, and a second normal mode winding 534. The first normal mode winding 532 can be electrically coupled to a first input 542 (e.g. a positive DC output) of the magnetic component 500. The second normal mode winding 534 can be electrically coupled to a second input 544 (e.g. a negative DC output) of the magnetic component 500. The first common mode winding 522 can be electrically coupled between the first normal mode winding 532 and a first output 546 (e.g. a positive DC input) of the magnetic component 500. The second common mode winding 524 can be electrically coupled between the second normal mode winding 534 and a second output 548 (e.g. a negative DC input).

The first normal mode winding 532 and the second normal mode winding 534 can be disposed about the first leg 512 of the core 510. The first common mode winding 522 can be disposed about the second leg 514 of the core 510. The second common mode winding 524 can disposed about the third leg 516 of the core 510. The first leg 512 can have an air gap 511 to affect the reluctance of the first leg 512 and the normal mode inductance provided by the first normal mode winding 532 and the second normal mode winding 534.

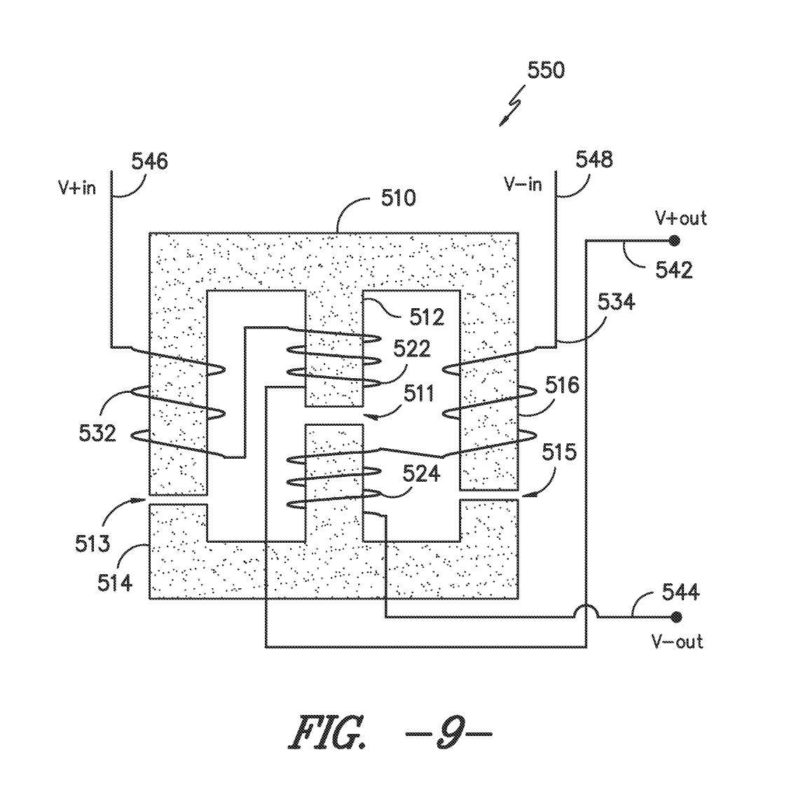

FIG. 9 depicts a magnetic component 550 according to another example embodiment of the present disclosure. The magnetic component 550 is similar to the magnetic component 500 of FIG. 8. However, an air gap 513 is provided in the second leg 514 of the core 510 and an air gap 515 is provided in the third leg 516 of the core 510. The air gap 513 can affect the reluctance of the second leg 514 and the common mode inductance of the first common mode winding 522. The air gap 515 can affect the reluctance of the third leg 516 and the common mode inductance of the second common mode winding 524. The air gap 511 can be larger in size than the air gaps 513 and 515.

The present disclosure is discussed with reference to magnetic components coupled between a DC link of a power system and an energy storage system for purposes of illustration and discussion. Those of ordinary skill in the art, using the disclosures provided herein, will understand that the magnetic components according to aspects of the present disclosure can be used with other types of power systems and/or topologies. For instance, the magnetic components can be used in a wind, solar, gas turbine, or other suitable power generation system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A wind turbine power system, comprising:
a wind driven generator configured to generate AC power;
a power converter coupled to the generator, the power converter comprising a first converter configured to convert AC power to DC power, a second converter configured to convert DC power to AC power, and a DC bus coupled between the first converter and the second converter; and
a magnetic component, the magnetic component comprising a core having a plurality of legs, the plurality of legs comprising a first leg, a second leg, and a third leg, each of the plurality of legs configured to provide a flux path in the core;
wherein the magnetic component comprises:
at least one common mode winding, the at least one common mode winding disposed about the first leg, the at least one common mode winding configured to provide a common mode inductance for the power system; and
at least one normal mode winding, the at least one normal mode winding disposed about the second leg, the normal mode winding configured to provide a normal mode inductance for the power system, the at least one common mode winding coupled between the at least one normal mode winding and a DC output of the magnetic component.

2. The wind turbine power system of claim 1, wherein the at least one common mode winding comprises a first common mode winding and a second common mode winding and the at least one normal mode winding comprises a first normal mode winding and a second normal mode winding.

3. The wind turbine power system of claim 2, wherein the first normal mode winding is coupled to a first DC input and the second normal mode winding is coupled to a second DC input, the first common mode winding coupled between the first normal mode winding and a first DC output, the second common mode winding coupled between the second normal winding and a second DC output.

4. The wind turbine power system of claim 3, wherein the first common mode winding and the second common mode winding are disposed about the first leg.

5. The wind turbine power system of claim 4, wherein the first normal mode winding is disposed about the second leg of the plurality of legs, and the second normal mode winding is disposed about the third leg of the plurality of legs.

6. The wind turbine power system of claim 5, wherein the first leg of the plurality of legs is disposed between the second leg and third leg in the core.

7. The wind turbine power system of claim 5, wherein the second leg and the third leg each comprise a gap.

8. The wind turbine power system of claim 5, wherein the first leg, the second leg, and the third leg each comprise a gap.

9. The wind turbine power system of claim 4, wherein the first normal mode winding and the second normal mode winding are disposed about the second leg.

10. The wind turbine power system of claim 7, wherein the second leg comprises a gap.

11. The wind turbine power system of claim 8, wherein the first leg comprises a gap, the gap in the first leg being smaller than the gap in the second leg.

12. The wind turbine power system of claim 3, wherein the first normal mode winding and the second normal mode winding are disposed about the first leg.

13. The wind turbine power system of claim 10, wherein the first common mode winding is disposed about the second leg and the second common mode winding is disposed about the third leg.

14. The wind turbine power system of claim 11, wherein the first leg comprises a gap.

15. The wind turbine power system of claim 11, wherein the second leg and the third leg comprise a gap, the gap in the second leg and the gap in the third leg being smaller than the gap in the first leg.

16. The wind turbine power system of claim 1, wherein the magnetic component is coupled between the DC bus and an energy storage system.

17. A magnetic component for providing common mode and normal mode inductance in a power system, comprising:
a core having a plurality of legs, the plurality of legs comprising a first leg, a second leg, and a third leg, each of the plurality of legs configured to provide a flux path in the core;
at least one common mode winding, the at least one common mode winding disposed about the first leg, the at least one common mode winding configured to provide a common mode inductance for the power system; and
at least one normal mode winding, the at least one normal mode winding disposed about the second leg, the normal mode winding configured to provide a normal mode inductance for the power system, the at least one common mode winding coupled between the at least one normal mode winding and a DC output of the magnetic component.

18. The magnetic component of claim 15, wherein the at least one common mode winding comprises a first common mode winding and a second common mode winding and the at least one normal mode winding comprises a first normal mode winding and a second normal mode winding.

19. The magnetic component of claim 16, wherein the first common mode winding and the second common mode winding are disposed about the first leg.

20. The magnetic component of claim 17, wherein the first normal mode winding is disposed about the second leg of the plurality of legs, and the second normal mode winding is disposed about the third leg.

21. The magnetic component of claim 17, wherein the first normal mode winding and the second normal mode winding are disposed about the second leg.

22. The magnetic component of claim 16, wherein the first normal mode winding and the second normal mode winding are disposed about the first leg, the first common mode winding is disposed about the second leg, and the second common mode winding is disposed about the third leg.
